(19) United States
(12) Patent Application Publication
(10) Pub. No.: US 2017/0001641 A1
(43) Pub. Date: Jan. 5, 2017

(54) VEHICLE SPEED CONTROL SYSTEM

(71) Applicant: HONDA MOTOR CO., LTD., Tokyo (JP)

(72) Inventor: Yuji YASUI, Wako-shi (JP)

(21) Appl. No.: 15/183,251

(22) Filed: Jun. 15, 2016

(30) Foreign Application Priority Data
Jun. 30, 2015 (JP) 2015-131330

(51) Int. Cl. B60W 30/16; G01P 7/00

(52) U.S. Cl. CPC B60W 30/16; G01P 7/00; B60W 2520/10

(57) ABSTRACT

A vehicle speed control system capable of improving all of calculation accuracy of corrected vehicle speed, controllability of cruise control, and safety and marketability of the system. Vehicle speed control system includes FI ECU and meter ECU. The meter ECU calculates meter vehicle speed, and transmits the same to the FI ECU via CAN communication network. The FI ECU calculates controller vehicle speed, calculates CC vehicle speed by correcting the controller vehicle speed with a vehicle speed correction coefficient, updates and stores local correction coefficients such that the difference between the speeds is reduced while causing correlation between the speeds to be reflected thereon according to the controller vehicle speed, calculates the vehicle speed correction coefficient using the stored coefficients, determines a target vehicle speed, and performs cruise control such that the CC vehicle speed becomes equal to the target vehicle speed.

### BACKGROUND OF THE INVENTION

Field of the Invention

The present invention relates to a vehicle speed control system that calculates, based on a vehicle speed detection signal, a display vehicle speed for display on a vehicle speed-displaying section of a vehicle, such as a speedometer, and a controller vehicle speed which is distinct from the vehicle speed for display, and performs cruise control using the controller vehicle speed.

Description of the Related Art

Conventionally, a vehicle speed control system is known which is disclosed in Japanese Laid-Open Patent Publication No. 2007-326494. The vehicle speed control system includes a vehicle speed sensor, a cruise control switch, a speedometer ECU, a controller for engine control, and so forth. The speedometer ECU calculates a display vehicle speed based on a detection signal output from the vehicle speed sensor, and drives the speedometer to display the display vehicle speed. Further, the speedometer ECU is connected to the controller for engine control via a CAN communication network, whereby data communication using a CAN protocol is performed between the speedometer ECU and the controller for engine control.

Further, the controller for engine control calculates, in a case where conditions for performing cruise control are satisfied, a controller vehicle speed based on a detection signal output from the vehicle speed sensor, and a target vehicle speed based on a setting state of the cruise control switch. Then, the degree of opening of a throttle valve is controlled via a throttle valve motor such that the controller vehicle speed becomes equal to the target vehicle speed during execution of cruise control.

According to the vehicle speed control system disclosed in Japanese Laid-Open Patent Publication No. 2007-326494, the display vehicle speed is calculated by modifying a detection signal output from the vehicle speed sensor because of various legal regulations, and hence the display vehicle speed shows a different value from a value of the controller vehicle speed even though the vehicle speed is calculated based on the same detection signal output from the vehicle speed sensor. As a result, when the cruise control is performed, the display vehicle speed deviates from the target vehicle speed even though the controller vehicle speed has reached the target vehicle speed, so that a driver feels a sense of incompatibility or a sense of degraded controllability, which reduces the marketability of the system.

As a solution to the above-described problem of the vehicle speed control system disclosed in Japanese Laid-Open Patent Publication No. 2007-326494, although no patent literature therefor has been found, recent vehicle speed control systems use a method of calculating a ratio between the display vehicle speed and the controller vehicle speed as a correction coefficient, calculating a corrected vehicle speed by multiplying the controller vehicle speed with this correction coefficient, and performing the cruise control based on the corrected vehicle speed. However, the method of using the corrected vehicle speed has the following problem:

In a transient state before the corrected vehicle speed is converged to the target vehicle speed due to execution of the cruise control, a result of calculation of the correction coefficient is unstable, and hence to avoid the influence of the unstable calculation result, it is required to refrain from updating the correction coefficient until the corrected vehicle speed becomes close to the target vehicle speed, and start calculation of the correction coefficient when the corrected vehicle speed becomes close to the target vehicle speed to some degree. As a result, immediately after the start of the cruise control, a steady-state deviation of the corrected vehicle speed from the target vehicle speed is generated, and calculation of the correction coefficient is started from this state. Therefore, it takes time before the display vehicle speed reaches the target vehicle speed, which makes the driver feel that the controllability of the cruise control is low.

Further, in the case of the above-described method using the corrected vehicle speed, when the speedometer ECU goes faulty, causing rapid lowering of the display vehicle, the correction coefficient is rapidly reduced, and accordingly, the corrected vehicle speed is also rapidly reduced to become considerably lower than the actual vehicle speed. If the cruise control is performed in this state, the vehicle is rapidly accelerated so as to make the corrected vehicle speed, which has been rapidly reduced, closer to the target vehicle speed, and a rapid acceleration state or an increased speed state, which is not intended by the driver, is generated, which lowers the safety. Particularly, in the functional safety standards (ISO26262) in recent years, for example, even when the speedometer ECU goes faulty, the vehicle is required to suppress generation of a rapid acceleration state or an increased speed state, which is not intended by the driver, and enable the driver to avoid, when the driver has noticed the faulty state, the lowered safety state by a braking operation or a shifting operation of the driver.

In addition to this, in a case where data communication is performed between the speedometer ECU and the controller for engine control using the CAN protocol as performed in the vehicle speed control system disclosed in Japanese Laid-Open Patent Publication No. 2007-326494, the control period of the controller for engine control is generally shorter than the data communication period. For this reason, in the vehicle speed control system disclosed in Japanese Laid-Open Patent Publication No. 2007-326494, the correction coefficient is sometimes changed in a stepped manner or shows a vibrational behavior due to a difference between the period of calculation of the correction coefficient (i.e. control period) and the data communication period, which may lower controllability.

### SUMMARY OF THE INVENTION

It is an object of the present invention to provide a vehicle speed control system that is capable of improving all of the accuracy of calculation of a corrected vehicle speed, the controllability of the cruise control, and the safety and marketability of the system.

To attain the above object, the present invention provides a vehicle speed control system comprising vehicle speed-detecting means for outputting a vehicle speed detection signal indicative of a vehicle speed which is a speed of a vehicle, display vehicle speed-calculating means for calculating a display vehicle speed for display on a vehicle speed-displaying section of the vehicle, based on the vehicle speed detection signal, controller vehicle speed-calculating means for calculating a controller vehicle speed which is distinct from the display vehicle speed, based on the vehicle speed detection signal, corrected vehicle speed-calculating means for calculating a corrected vehicle speed by correcting the controller vehicle speed with a correction value, correction component-updating and storing means for updating and storing a correction component with a predetermined control algorithm while causing a correlation between the corrected vehicle speed and the display vehicle speed to be reflected thereon in association with a vehicle speed parameter indicative of the vehicle speed, such that an error between the corrected vehicle speed and the display vehicle speed is reduced, and storing the updated correction component, correction value-calculating means for calculating the correction value using the stored correction component, target vehicle speed-determining means for determining a target vehicle speed which is a target of the corrected vehicle speed, and cruise control means for performing cruise control for controlling a motive power source of the vehicle, such that the corrected vehicle speed becomes equal to the target vehicle speed.

According to this vehicle speed control system, the display vehicle speed for display on the vehicle speed-displaying section of the vehicle is calculated based on the vehicle speed detection signal, the controller vehicle speed which is distinct from the display vehicle speed is calculated based on the vehicle speed detection signal, the corrected vehicle speed is calculated by correcting the controller vehicle speed with the correction value, the target vehicle speed which is a target of the corrected vehicle speed is determined, and the cruise control for controlling the motive power source of the vehicle is performed such that the corrected vehicle speed becomes equal to the target vehicle speed. Further, the correction component is updated with the predetermined control algorithm while causing the correlation between the corrected vehicle speed and the display vehicle speed to be reflected thereon in association with the vehicle speed parameter indicative of the vehicle speed, such that the error between the corrected vehicle speed and the display vehicle speed is reduced, and is stored. Then, the correction value is calculated using the stored correction component, and hence by using the thus calculated correction value, it is possible to calculate the corrected vehicle speed in a state in which the error between the corrected vehicle speed and the display vehicle speed is reduced. That is, it is possible to calculate the corrected vehicle speed in a state in which the corrected vehicle speed follows the display vehicle speed with high accuracy. Further, by using the correction value calculated as above, it is possible to calculate the corrected vehicle speed in a state in which the correlation between the corrected vehicle speed and the display vehicle speed is stored in association with the vehicle speed parameter. As a result, when the cruise control is performed using the corrected vehicle speed calculated as above, differently from the vehicle speed control system disclosed in Japanese Laid-Open Patent Publication No. 2007-326494, a steady-state deviation of the corrected vehicle speed from the target vehicle speed is not generated even immediately after the start of the cruise control, and the cruise control is performed from this state, whereby it is possible to cause the display vehicle speed to quickly reach the target vehicle speed. This makes it possible to improve the controllability of the cruise control and the marketability of the system.

Preferably, the correction component-updating and storing means updates the correction component while causing the correlation to be reflected thereon, such that the error is reduced, and at the same time such that an absolute value of acceleration estimated to be generated in the vehicle when the cruise control is performed using the corrected vehicle speed becomes smaller than a predetermined maximum value.

According to the configuration of the preferred embodiment, the correction component is updated while causing the correlation to be reflected thereon, such that the error is reduced, and at the same time such that the absolute value of acceleration estimated to be generated in the vehicle when the cruise control is performed using the corrected vehicle speed becomes smaller than the predetermined maximum value. Therefore, it is possible to avoid occurrence of a rapid acceleration state when the cruise control is performed using the corrected vehicle speed. Particularly, even when the display vehicle speed is rapidly reduced due to a failure of the display vehicle speed-calculating means, it is possible to avoid occurrence of the rapid acceleration state. This makes it possible to improve all of the controllability of the cruise control, and the safety and marketability of the system.

Preferably, the correction component is formed by a plurality of correction components associated with a plurality of regions of the vehicle speed parameter, respectively, and the correction value-calculating means calculates the correction value as the sum of respective products of the plurality of correction components, and a plurality of function values set in a manner associated with the plurality of regions, respectively, the plurality of function values being set such that each function value indicates a value of the same sign in an associated one of the regions, and each two adjacent function values overlap each other with respect to the vehicle speed parameter.

According to the configuration of the preferred embodiment, the correction value is calculated as the sum of the respective products of the plurality of correction components associated with the plurality of regions of the vehicle speed parameter, respectively, and the plurality of function values set in a manner associated with the plurality of regions, respectively, and the plurality of function values are set such that each function value indicates a value of the same sign in an associated one of the regions, and each two adjacent function values overlap each other with respect to the vehicle speed parameter. Therefore, even in a case where the correlation between the corrected vehicle speed and the display vehicle speed has a characteristic that the correlation rapidly changes with respect to the vehicle speed parameter, it is possible to calculate the correction value, i.e. the corrected vehicle speed, while avoiding the influence of such rapid change in correlation. This makes it possible to further improve the controllability of the cruise control, and the safety and marketability of the system.

Preferably, the display vehicle speed-calculating means is provided separately from the correction component-updating and storing means, and the vehicle speed control system further comprises transmission means for transmitting the display vehicle speed calculated by the display vehicle speed-calculating means to the correction component-updating and storing means at a predetermined transmission period, the correction component-updating and storing means being configured to update and store the correction component in synchronism with the predetermined transmission period, and the correction value-calculating means calculating the correction value at a predetermined control period which is shorter than the predetermined transmission period.

According to the configuration of the preferred embodiment, the correction component is updated and stored in synchronism with the transmission period of the display vehicle speed. Therefore, differently from the vehicle speed control system disclosed in Japanese Laid-Open Patent Publication No. 2007-326494, it is possible to prevent the correction component from being changed in a stepped manner or showing a vibrational behavior due to a difference between the updating period of the correction component and the transmission period of the display vehicle speed. Further, the correction value is calculated using the thus updated and stored correction component, at the predetermined control period, and hence it is possible to improve the accuracy of calculation of the correction value, and thereby secure excellent controllability.

Preferably, the vehicle speed control system further comprises first target speed-setting means for setting a first target speed according to an operation of a driver of the vehicle, and second target speed-setting means for setting a second target speed according to the vehicle speed and a positional relationship between the vehicle and a preceding vehicle located ahead of the vehicle, and the target vehicle speed-determining means selects one of the first target speed and the second target speed as a target speed.

According to the configuration of the preferred embodiment, the first target speed is set according to an operation of a driver of the vehicle, the second target speed is set according to the vehicle speed and the positional relationship between the vehicle and a preceding vehicle located ahead of the vehicle, and one of the first target speed and the second target speed is selected as the target speed. Therefore, when the second target speed is selected as the target speed, the target vehicle speed is changed according to the vehicle speed and the positional relationship between the vehicle and the preceding vehicle located ahead of the vehicle. In this case, the corrected vehicle speed is calculated as described above, and hence even when the target speed is changed, it is possible to cause the corrected vehicle speed to follow the target speed with high accuracy, and thereby perform the cruise control with high accuracy.

The above and other objects, features, and advantages of the present invention will become more apparent from the following detailed description taken in conjunction with the accompanying drawings.

### BRIEF DESCRIPTION OF THE DRAWINGS

FIG. 1 is a schematic diagram of a vehicle speed control system according to an embodiment of the present invention, and a vehicle to which the vehicle speed control system is applied;

FIG. 2 is a functional block diagram of the vehicle speed control system;

FIG. 3A is a diagram showing an example of a relationship between a controller vehicle speed and the difference between the controller vehicle speed and a display vehicle speed;

FIG. 3B is an example of a map for use in calculating first to fourth weighting function values;

FIG. 4A is a diagram showing a result of calculation of the difference between the controller vehicle speed and the display vehicle speed, with respect to the controller vehicle speed;

FIG. 4B is a diagram showing a result of calculation of the product of a first weighting function value and a first local correction coefficient, with respect to the controller vehicle speed;

FIG. 4C is a diagram showing a result of calculation of the product of a second weighting function value and a second local correction coefficient, with respect to the controller vehicle speed;

FIG. 4D is a diagram showing a result of calculation of the product of a third weighting function value and a third local correction coefficient, with respect to the controller vehicle speed;

FIG. 4E is a diagram showing a result of calculation of the product of a fourth weighting function value and a fourth local correction coefficient, with respect to the controller vehicle speed;

FIG. 4F is a diagram showing a result of calculation of a vehicle speed correction coefficient, with respect to the controller vehicle speed;

FIG. 5 is a flowchart of a cruise control process;

FIG. 6 is a flowchart of a process for calculating a corrected vehicle speed;

FIG. 7 is a flowchart of a process for updating local correction coefficients;

FIG. 8 is a timing diagram showing results of a simulation of a vehicle speed difference and the display vehicle speed, obtained when the cruise control process according to the embodiment is performed; and

FIG. 9 is a timing diagram showing, for comparison, results of a simulation of the vehicle speed difference and the display vehicle speed, obtained when the cruise control process is performed while updating only the first local correction coefficient, and holding the first weighting function value at 1.

### DETAILED DESCRIPTION OF PREFERRED EMBODIMENTS

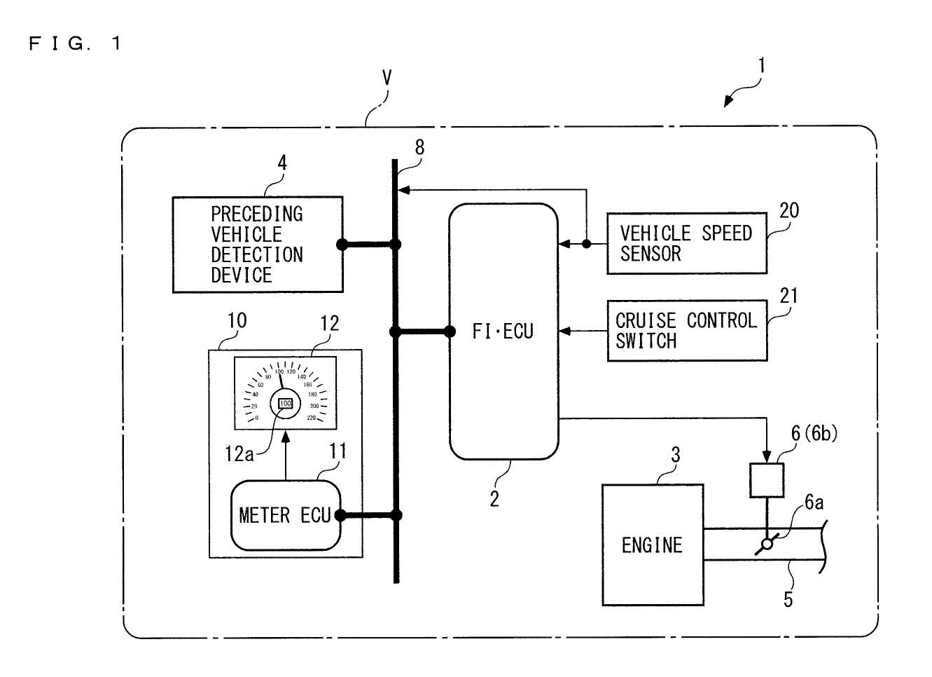

Hereafter, a vehicle speed control system according to an embodiment of the present invention will be described with reference to drawings. The vehicle speed control system, denoted by reference numeral 1, according to the present embodiment performs a cruise control process and the like for a vehicle V shown in FIG. 1. The vehicle V is a four-wheel type vehicle (not shown), and is equipped with an FI ECU 2, an engine 3, a preceding vehicle detection device 4, a vehicle speed display device 10, and so forth.

The engine 3 is a gasoline engine, and is installed on the vehicle V as a motive power source. The operating state of the engine 3 is controlled by the FI ECU 2. An intake passage 5 of the engine 3 is provided with a throttle valve mechanism 6.

The throttle valve mechanism 6 includes a throttle valve 6a and a TH actuator 6b which actuates the throttle valve 6a to open and close the same. The throttle valve 6a is pivotally disposed in an intermediate portion of the intake passage and changes the amount of air passing therethrough by a change in the degree of opening caused by the pivotal motion thereof. The TH actuator 6b is formed by combining a motor (not shown) connected to the FI ECU 2 and a gear mechanism (not shown), and is electrically connected to the FI ECU 2. The FI ECU 2 drives the TH actuator 6b to control the degree of opening of the throttle valve 6a, whereby the amount of intake air drawn into the cylinder of the engine 3 is controlled.

Further, a vehicle speed sensor 20 and a cruise control switch 21 are connected to the FI ECU 2. The vehicle speed sensor 20 (vehicle speed-detecting means) detects a vehicle speed which is a speed of the vehicle V, outputs a vehicle speed detection signal indicative of the detected vehicle speed to the FI ECU 2, and also outputs the vehicle speed detection signal to a meter ECU 11, referred to hereinafter, via a CAN communication line 8 (communication means).

On the other hand, the cruise control switch 21 enables a driver to select a CC control mode or an ACC control mode as a cruise control mode, and set a CC target vehicle speed Vr_c (first target vehicle speed) which is a target vehicle speed in the CC control mode.

The CC control mode is a control mode for controlling the vehicle speed such that it becomes equal to the CC target vehicle speed Vr_c set by the driver, and the ACC control mode is a control mode for controlling the vehicle speed based on preceding vehicle data detected by the preceding vehicle detection device 4, as will be described hereinafter. A switch setting state signal indicative of a selected state of the control mode by the driver and a state of setting of the cruise control switch 21, including an ON/OFF state thereof, is output from the cruise control switch 21 to the FI ECU 2.

Further, the above-mentioned preceding vehicle detection device 4 has the same arrangement as that proposed by the present applicant in Japanese Laid-Open Patent Publication No. 2002-178786, and hence although detailed description thereof is omitted, the preceding vehicle detection device 4 detects the preceding vehicle data including a distance to a preceding vehicle, and a direction and a relative speed of the preceding vehicle, by using laser light.

The preceding vehicle detection device 4 is connected to the FI ECU 2 via the CAN communication line 8, and data communication using a CAN (Controller Area Network) protocol is performed between the preceding vehicle detection device 4 and the FI ECU 2. By this data communication, the preceding vehicle data detected by the preceding vehicle detection device 4 is transmitted to the FI ECU 2 via the CAN communication line 8.

Further, the above-mentioned vehicle speed display device 10 displays the vehicle speed, and includes the meter ECU 11 (display vehicle speed-calculating means) and a speedometer 12 (vehicle speed-displaying section). The meter ICU 11 is implemented by a microcomputer comprised of a CPU, a RAM, a ROM, and an I/O interface (none of which are specifically shown), and is connected to the FI ECU 2 via the CAN communication line 8.

When the above-mentioned vehicle speed detection signal is input to the meter ECU 11 via the CAN communication line 8, the meter ECU 11 calculates a display vehicle speed Vmeter based on the input vehicle speed detection signal, drives the speedometer 12 to cause the same to display the display vehicle speed Vmeter, and outputs data of the display vehicle speed Vmeter (hereinafter referred to as the “display vehicle speed data”) to the FI ECU 2 via the CAN communication line 8.

Further, the speedometer 12 has a CC target vehicle speed-displaying section 12a provided in a central portion thereof. When a driver sets the CC target vehicle speed Vr_c which is the target vehicle speed for the CC control mode by operating the cruise control switch 21, the FI ECU 2 transmits data of the CC target vehicle speed Vr_c to the vehicle speed display device 10 via the CAN communication line 8. This causes the CC target vehicle speed Vr_c to be displayed on the CC target vehicle speed-displaying section 12a.

Further, the FI ECU 2 is implemented by a microcomputer comprised of a CPU, a RAM, a ROM, and an I/O interface (none of which are specifically shown), and performs various control processes including the cruise control process, as described hereinafter, based on the above-mentioned switch setting state signal, vehicle speed detection signal, preceding vehicle data, and display vehicle speed data.

Note that in the present embodiment, the FI ECU corresponds to controller vehicle speed-calculating means, corrected vehicle speed-calculating means, correction component-updating and storing means, correction value-calculating means, target vehicle speed-determining means, cruise control means, first target speed-setting means, and second target speed-setting means.

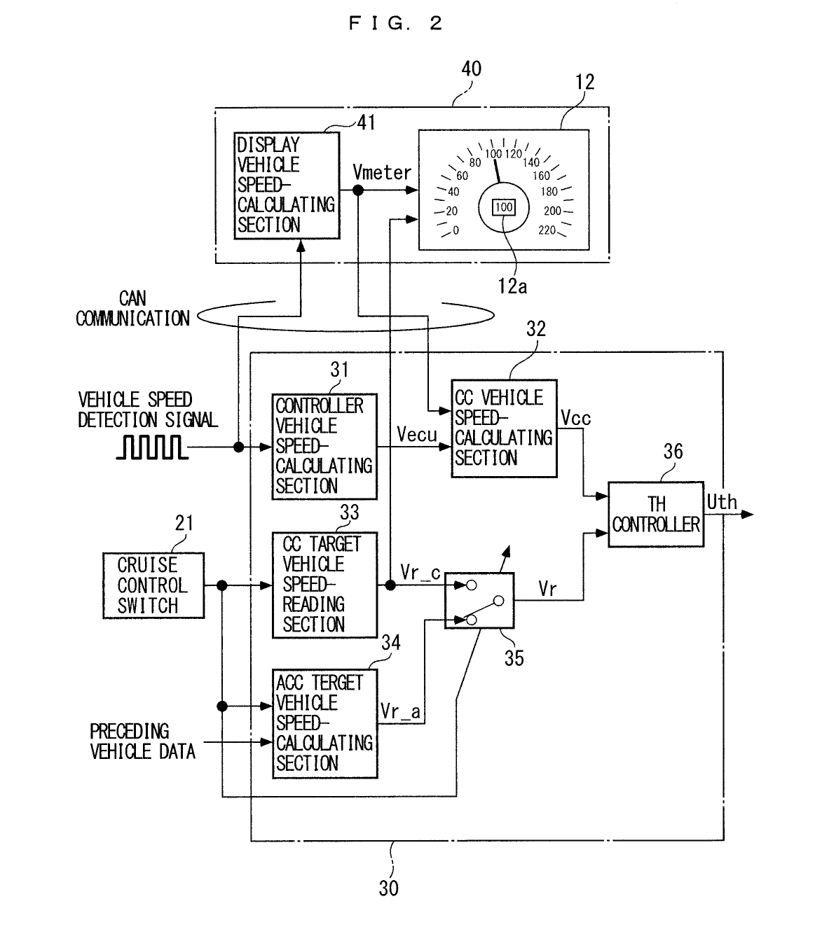

Next, a description will be given of the functional configuration of the vehicle speed control system 1 according to the present embodiment, with reference to FIG. 2. Note that, in the following description, discrete data with a symbol (k) indicates that it is data calculated or sampled by the FI ECU 2 at a predetermined control period DTk (e.g. 10 to 50 msec), and discrete data with a symbol (n) indicates that it is data calculated or sampled by the FI ECU 2 at a control period DTn synchronized with a communication period DTn of data communication performed via the above-mentioned CAN communication line 8.

In this case, since the control period DTn is a value synchronized with the communication period of the CAN communication line 8, the control period DTn is set to a value larger than the control period DTk, and is set to 2·DTk, i.e. a value twice the control period DTk, in the present embodiment. Further, in the following description, the symbols (k) and (n) provided for the discrete data are omitted as deemed appropriate.

Referring to FIG. 2, the vehicle speed control system 1 includes a cruise controller 30 and a meter controller 40. Specifically, the cruise controller 30 is formed by the FI ECU 2, and the meter controller 40 is formed by the meter ECU 11.

The meter controller 40 includes a display vehicle speed-calculating section 41. The display vehicle speed-calculating section 41 calculates the display vehicle speed Vmeter based on the vehicle seed detection signal input from the vehicle speed sensor 20 with a predetermined calculation algorithm, and outputs the calculated display vehicle speed Vmeter to the speedometer 12. This causes the display vehicle speed Vmeter to be displayed on the speedometer 12.

Further, the display vehicle speed-calculating section 41 transmits a result of calculation of the display vehicle speed Vmeter to a CC vehicle speed-calculating section 32, referred to hereinafter, of the cruise controller 30 via the CAN communication line 8 at the above-mentioned communication period.

Further, as described above, when the cruise controller 30 sets the CC target vehicle speed Vr_c based on the operation of the cruise control switch 21, the CC target vehicle speed Vr_c is transmitted from the cruise controller 30 to the meter controller 40 via the CAN communication line 8. This causes the CC target vehicle speed Vr_c to be displayed on the CC target vehicle speed-displaying section 12a.

On the other hand, the cruise controller 30 includes a controller vehicle speed-calculating section 31, the CC vehicle speed-calculating section 32, a CC target vehicle speed-reading section 33, an ACC target vehicle speed-calculating section 34, a target vehicle speed-selecting section 35, and a TH controller 36.

The controller vehicle speed-calculating section 31 calculates a controller vehicle speed Vecu based on the vehicle speed detection signal input from the vehicle speed sensor 20 at the above-mentioned control period DTk, with a predetermined calculation algorithm, and outputs the same to the CC vehicle speed-calculating section 32.

Further, the CC vehicle speed-calculating section 32 calculates a CC vehicle speed Vcc using the above-mentioned controller vehicle speed Vecu and the display vehicle speed Vmeter input from the display vehicle speed-calculating section 41 by a method, described hereafter, and outputs the result of calculation to the TH controller 36.

First, a vehicle speed correction coefficient Kv (correction value) is calculated by the following equation (1), and then the CC vehicle speed Vcc (corrected vehicle speed) is calculated by the following equation (2):

$$\begin{matrix}Kv ( k ) = {\sum }_{i = 1}^{4} Kv\_i ( k ) \cdot W\_i ( k ) & ( 1 ) \\ Vcc ( k ) = Kv ( k ) \cdot Vecu ( k ) & ( 2 )\end{matrix}$$

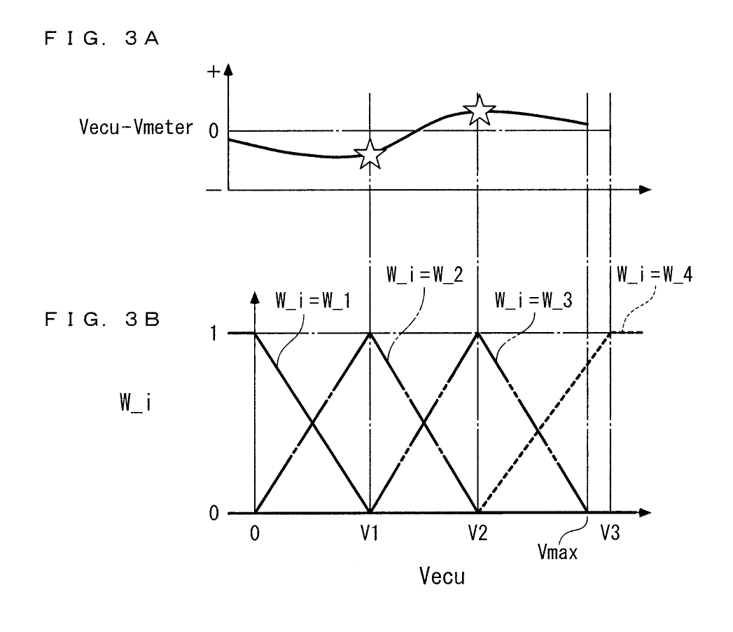

In the equation (1), Kv_i (i=1 to 4) represents one of first to fourth local correction coefficients (correction components), and an update algorithm (i.e. calculation algorithm) for updating these local correction coefficients Kv_i will be described hereinafter. Further, W_i in the equation (1) represents one of first to fourth weighting function values, and the values of these weighting function values W_i are calculated by searching a map shown in FIG. 3B according to the controller vehicle speed Vecu.

Referring to FIG. 3B, 3V1 to V3 and Vmax represent predetermined values of the controller vehicle speed Vecu, satisfying 0<V1<V2<Vmax<V3, and particularly, Vmax represents a predetermined maximum vehicle speed. As shown in FIG. 3B, the first weighting function value W_1 corresponds to a first region defined as Vecu<V1, the second weighting function value W_2 corresponds to a second region defined as 0<Vecu<V2, the third weighting function value W_3 corresponds to a third region defined as V1<Vecu<Vmax, and the fourth weighting function value W_4 corresponds to a fourth region defined as V2<Vecu<V3.

Further, each of the four weighting function values W_i is set to a positive value not larger than 1 in each associated one of the above-mentioned regions, and is set to 0 in regions other than the associated region(s), and each two adjacent weighting function values are set such that they overlap each other.

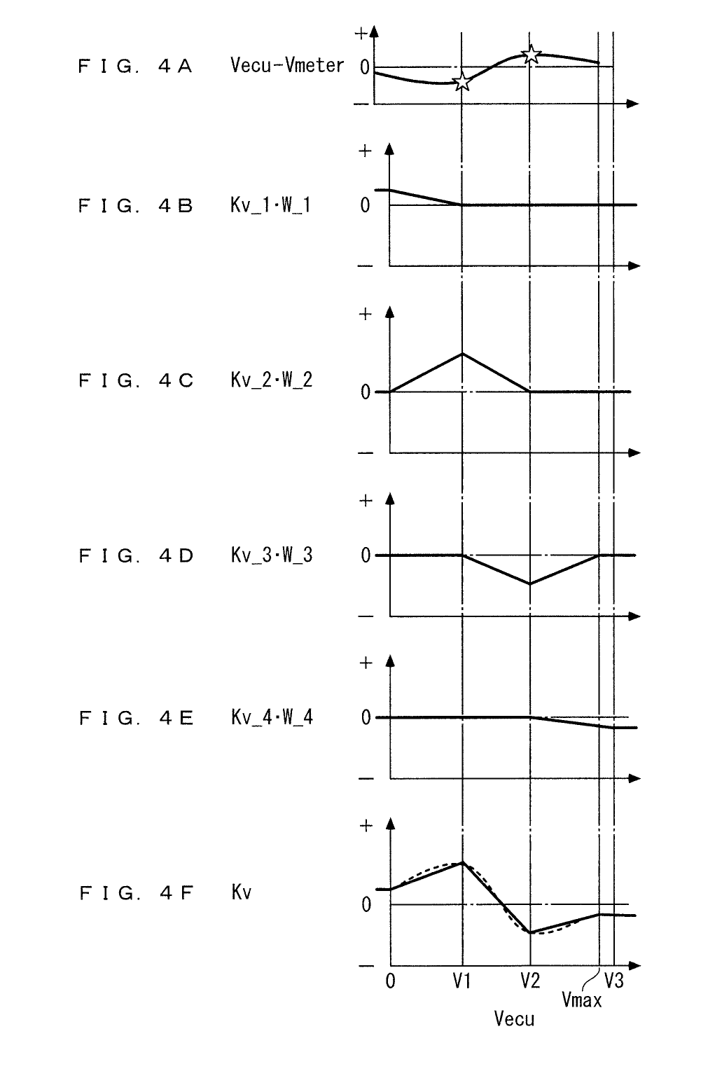

Further, as shown in FIGS. 3A and 3B, peak points of the second weighting function value W_2 and the third weighting function value W_3 are set such that they are located at inflection points of a difference Vecu−Vmeter between the controller vehicle speed Vecu and the display vehicle speed Vmeter. This is for the following reason: In a case where the peak points of the two the weighting function values W_2 and W_3 are set such that they are located at the inflection points of the difference Vecu−Vmeter, it is possible to make the vehicle speed correction coefficient Kv closer to an ideal value (a value indicated by a broken line in FIG. 4F), referred to hereinafter, than in a case where the same are set such that they are located at points other than the inflection points, whereby the followability of the CC vehicle speed Vcc to the display vehicle speed Vmeter is improved.

Next, the above-mentioned update algorithm for updating the four local correction coefficients Kv_i (i=1 to 4) will be described. In the CC vehicle speed-calculating section 32, the four local correction coefficients Kv_i are updated by a method described hereafter at the above-mentioned control period DTn. This is because the display vehicle speed Vmeter is transmitted from the display vehicle speed-calculating section 41 to the CC vehicle speed-calculating section 32 at the above-mentioned communication period.

First, an update execution flag F_Vcc_adj is calculated by the following equations (3) and (4):
When V_L≦Vecu(n)≦V_H

F_Vcc_adj(n)=1 (3)
When Vecu(n)<V_L or V_H<Vecu (n)

F_Vcc_adj(n)=0 (4)

In the equations (3) and (4), V_L represents a predetermined lower limit value, and V_H represents a predetermined upper limit value.

Then, a CC vehicle speed Vcc_hat for update is calculated by the following equation (5):

Vcc_hat(n)=Kv(n)·Vecu(n) (5)

Further, a follow-up error ev_adp is calculated by the following equations (6) and (7):
When F_Vcc_adj=1

ev_adp(n)=Vcc_hat(n)−Vmeter(n) (6)
When F_Vcc_adj=0

ev_adp(n)=0 (7)

Further, a correction term dKv_unlmt is calculated with a fixed gain identification algorithm expressed by the following equation (8) such that the follow-up error ev_adp is minimized:

$$dKv\_un1mt ( n ) = \frac{Kadp\_v \cdot Vecu ( n )}{1 + Kadp\_v \cdot {Vecu ( n )}^{2}} \cdot ev\_adp ( n ) \qquad ( 8 )$$

In the equation (8), Kadp_v represents a predetermined gain (fixed value). In this case, since the correction term dKv_unlmt is calculated such that the follow-up error ev_adp is minimized, the correction term dKv_unlmt is calculated such that the update CC vehicle speed Vcc_hat is caused to follow the display vehicle speed Vmeter. That is, the correction term dKv_unlmt is calculated such that the CC vehicle speed Vcc is caused to follow the display vehicle speed Vmeter. Further, as expressed by the above-mentioned equation (7), when the update execution flag F_Vcc_adj is equal to 0, the follow-up error ev_adp is set to 0, and hence the correction term dKv_unlmt becomes equal to 0.

On the other hand, an acceleration limit value max_dKv_abs is calculated by the following equation (9):

$$max\_dKv \_abs ( n ) = \frac{G max \cdot K \cdot DTn}{Vecu ( n )} \qquad ( 9 )$$

In the equation (9), Gmax represents a predetermined maximum allowable acceleration (maximum value), and K represents a predetermined conversion coefficient. The acceleration limit value max_dKv_abs is a value for avoiding occurrence of a rapid acceleration/deceleration state which causes the driver to feel a sense of incompatibility when the cruise control is performed using the four local correction coefficients Kv_i.

Then, a limited correction term dKV_lmt is calculated by the following equations (10) to (12):
When dKv_unlmt (n)≧max_dKv_abs (n)

dKv_lmt(n)=max_dKv_abs(n) (10)
When −max_dKv_abs (n)<dKv_unlmt (n)<max_dKv_abs (n)

dKv_lmt(n)=dKv_unlmt(n) (11)
When −max_dKv_abs (n)≦dKv_unlmt (n)

dKv_lmt(n)=−max_dKv_abs(n) (12)

As expressed by the above-mentioned equations (10) to (12), the limited correction term dKV_lmt is calculated such that an absolute value thereof does not exceed the acceleration limit value max_dKv_abs, and hence is calculated as a value which makes it possible to avoid occurrence of a rapid acceleration/deceleration state which causes the driver to feel a sense of incompatibility when the cruise control is performed using this term.

Further, four local correction terms dKv_w_i (i=1 to 4) are calculated by the following equation (13):

dKv_w_i(n)=W_i(n)·dKv_lmt(n) (13)

As expressed by the equation (13), the four local correction terms dKv_w_i are each calculated by multiplying the four weighting function value W_i by the limited correction term dKv_lmt.

Then, finally, the four local correction coefficients Kv_i (i=1 to 4) are calculated by the following equation (14):

Kv_i(n)=Kv(n−1)+dKv_w_i(n) (14)

As expressed by the equation (14), the four local correction coefficients Kv_i are updated by correcting immediately preceding values Kv_i (n−1) thereof with the four local correction terms dKv_w_i, respectively. With the above-described update algorithm, the four local correction coefficients Kv_i are calculated, in each of the above-mentioned first to fourth regions of the controller vehicle speed Vecu, as values having a function for causing a correlation between the CC vehicle speed Vcc_hat for update and the display vehicle speed Vmeter, i.e. a correlation between the CC vehicle speed Vcc and the display vehicle speed Vmeter, to be reflected thereon, a function for causing the CC vehicle speed Vcc to follow the display vehicle speed Vmeter, and a function for making it possible to avoid occurrence of a rapid acceleration/deceleration state which causes the driver to feel a sense of incompatibility. Note that as described above, when the update execution flag F_Vcc_adj is equal to 0, the correction term dKv_unlmt becomes equal to 0, and hence the four local correction coefficients Kv_i are not updated but held at the immediately preceding values thereof.

When the four local correction coefficients Kv_i are updated with the above-described update algorithm, the vehicle speed correction coefficient Kv is calculated as shown in FIG. 4. More specifically, as the controller vehicle speed Vecu changes in a range of 0 to the predetermined value V3, in a case where the difference Vecu−Vmeter between the controller vehicle speed Vecu and the display vehicle speed Vmeter is generated in a state shown in FIG. 4A, respective products Kv_i·W_i of the four local correction coefficients Kv_i and the four weighting function values W_i are calculated as shown in FIGS. 4B to 4E, respectively.

In this case, since the four local correction coefficients Kv_i have the above-mentioned functions, each of the four products Kv_i·W_i is calculated, in each of the above-mentioned first to fourth regions of the controller vehicle speed Vecu, as a value having the function for causing the correlation between the CC vehicle speed Vcc and the display vehicle speed Vmeter to be reflected thereon, the function for making it possible to avoid occurrence of the above-mentioned rapid acceleration/deceleration state, and the function for causing the CC vehicle speed Vcc to follow the display vehicle speed Vmeter.

Then, since the vehicle speed correction coefficient Kv is calculated by the above-mentioned equation (1) as the sum of the four products Kv_i·W_i, the vehicle speed correction coefficient Kv is calculated as shown in FIG. 4F. A curve indicated by a broken line in FIG. 4F represents ideal values of the vehicle speed correction coefficient Kv, which can optimally correct the difference Vecu−Vmeter. As is clear from a comparison between the ideal values and the vehicle speed correction coefficient Kv, it is known that the vehicle speed correction coefficient Kv is calculated as a value approximately close to the corresponding ideal value. That is, by calculating the vehicle speed correction coefficient Kv using the respective products Kv_i·W_i of the four local correction coefficients Kv_i and the four weighting function values W_i, it is possible to improve the accuracy of calculation of the CC vehicle speed Vcc.

Further, in the CC vehicle speed-calculating section 32, as described above, the four local correction coefficients Kv_i are updated at the control period DTn, and the updated results of these four local correction coefficients Kv_i are stored in the RAM of the FI ECU 2 during the operation of the engine 3, and are stored in an E2PROM, not shown, when the engine is controlled to stop by turning off an ignition switch, not shown, by the driver. This makes it possible to start the update of the four local correction coefficients Kv_i using the data of the four local correction coefficients Kv_i stored in the E2PROM of the FI ECU 2 when the engine is started next time after being stopped.

Further, as expressed by the above-mentioned equation (1), the vehicle speed correction coefficient Kv is calculated at the control period DTk shorter than the control period DTn, and hence is calculated using oversampled values of the four local correction coefficients Kv_i stored in the RAM.

Next, when the CC control mode is selected by the switch setting state signal input from the cruise control switch 21, the CC target vehicle speed-reading section 33 reads the CC target vehicle speed Vr_c set by the driver at the control period DTk, outputs the read CC target vehicle speed Vr_c to the target vehicle speed-selecting section 35, and transmits the CC target vehicle speed Vr_c to the meter controller 40 via the CAN communication line 8 as described hereinabove.

On the other hand, when the ACC control mode is selected by the switch setting state signal input from the cruise control switch 21, the above-described ACC target vehicle speed-calculating section 34 calculates an ACC target vehicle speed Vr_a (second target vehicle speed) based on the preceding vehicle data input from the preceding vehicle detection device 4, at the control period DTk, with a predetermined control algorithm, and outputs the calculated ACC target vehicle speed Vr_a to the target vehicle speed-selecting section 35. In this case, as described above, since the preceding vehicle data is transmitted at the transmission period DTn longer than the control period DTk, the ACC target vehicle speed Vr_a is calculated by the ACC target vehicle speed-calculating section 34 using the oversampled values of the preceding vehicle data.

Further, the target vehicle speed-selecting section 35 selects one of the CC target vehicle speed Vr_c and the ACC target vehicle speed Vr_a as the target vehicle speed Vr, based on the switch setting state signal input from the cruise control switch 21, at the control period DTk, and outputs the result of selection to the TH controller 36. In this case, when the CC control mode is selected as the cruise control mode, the CC target vehicle speed Vr_c is selected as the target vehicle speed Vr, whereas when the ACC control mode is selected, the ACC target vehicle speed Vr_a is selected as the target vehicle speed Vr.

Then, the TH controller 36 calculates a control input Uth at the control period DTk with a predetermined control algorithm such that the CC vehicle speed Vcc becomes equal to the target vehicle speed Vr, and a control input signal corresponding to the control input Uth is supplied to the TH actuator 6b. This causes the degree of opening of the throttle valve 6a to be controlled such that the CC vehicle speed Vcc becomes equal to the target vehicle speed Vr. That is, the cruise control is performed.

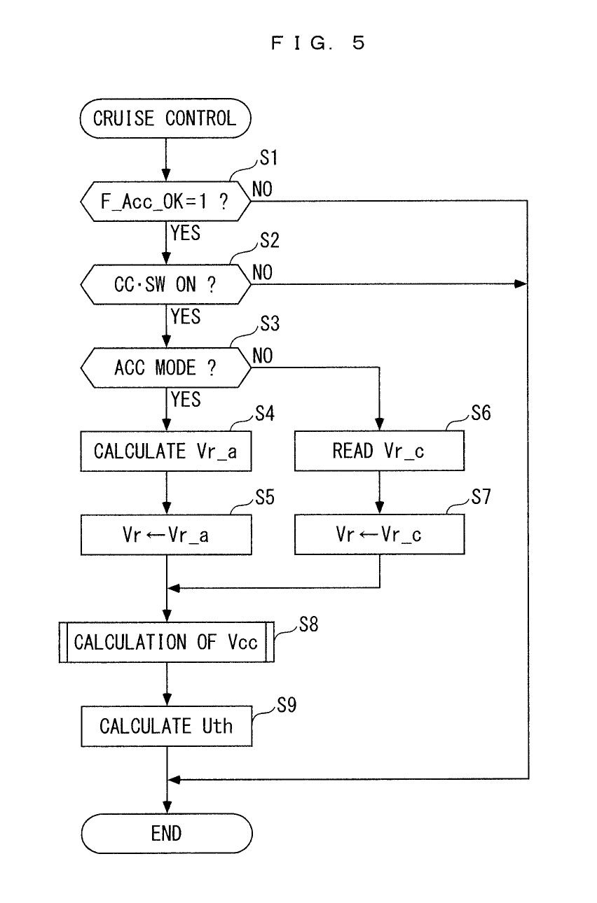

Next, a cruise control process will be described with reference to FIG. 5. This cruise control process calculates the control input Uth by using the above-described control method, and is performed by the FI ECU 2 at the above-mentioned control period DTk. Note that various values calculated and set by the cruise control process are stored in the RAM of the FI ECU 2.

Referring to FIG. 5, first, in a step 1 (shown as Si in abbreviated form in FIG. 5; the following steps are also shown in abbreviated form), it is determined whether or not a cruise control permission flag F_Acc_OK is equal to 1. The cruise control permission flag F_Acc_OK is set to 1 if it is determined in a determination process, not shown, that the above-mentioned devices including the preceding vehicle detection device 4 are normally operating, and is otherwise set to 0.

If the answer to the question of the step 1 is negative (NO), the present process is immediately terminated. On the other hand, if the answer to the question of the step 1 is affirmative (YES), i.e. if the devices are normally operating and hence the cruise control can be performed, the process proceeds to a step 2, wherein it is determined based on the switch setting state signal whether or not the cruise control switch (denoted in FIG. 5 as “CC·SW”) 21 is in the ON state.

If the answer to the question of the step 2 is negative (NO), it is determined that it is not necessary to perform the cruise control process, and the present process is immediately terminated.

On the other hand, if the answer to the question of the step 2 is affirmative (YES), it is determined that the cruise control process should be performed, and the process proceeds to a step 3, wherein it is determined based on the switch setting state signal whether or not the ACC control mode is selected as the cruise control mode.

If the answer to the question of the step 3 is affirmative (YES), i.e. if the ACC control mode is selected, the process proceeds to a step 4, wherein the ACC target vehicle speed Vr_a is calculated based on the switch setting state signal and the preceding vehicle data, with the predetermined control algorithm, as described hereinabove. Then, the process proceeds to a step 5, wherein the target vehicle speed Vr is set to the ACC target vehicle speed Vr_a.

On the other hand, if the answer to the question of the step 3 is negative (NO), i.e. if the CC control mode is selected, the process proceeds to a step 6, wherein the CC target vehicle speed Vr_c is read from the switch setting state signal. Then, the process proceeds to a step 7, wherein the target vehicle speed Vr is set to the CC target vehicle speed Vr_c.

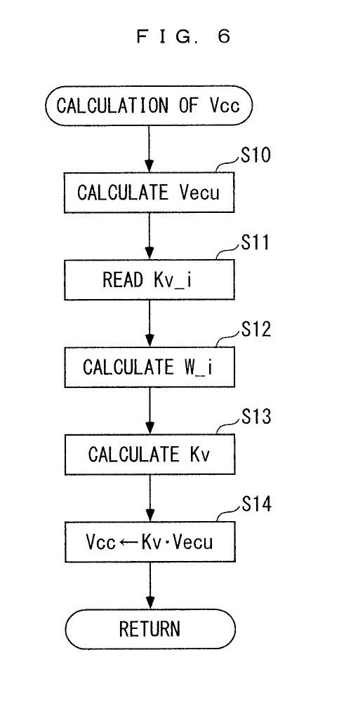

In a step 8 following the step 5 or 7, the CC vehicle speed Vcc is calculated. The CC vehicle speed Vcc is specifically calculated as shown in FIG. 6.

Referring to FIG. 6, first, in a step 10, the controller vehicle speed Vecu is calculated based on the vehicle speed detection signal.

Then, the process proceeds to a step 11, wherein the four local correction coefficients Kv_i stored in the RAM are read. In a case where this cruise control process is being performed immediately after the start of the engine, the four local correction coefficients Kv_i stored in the E2PROM are read as mentioned above.

Then, the process proceeds to a step 12, wherein the four weighting function values W_i are calculated by searching the map in FIG. 3B according to the controller vehicle speed Vecu.

In a step 13 following the step 12, the vehicle speed correction coefficient Kv is calculated by the above-mentioned equation (1).

Then, the process proceeds to a step 14, wherein the CC vehicle speed Vcc is set to the product Kv·Vecu of the vehicle speed correction coefficient Kv and the controller vehicle speed Vecu, followed by terminating the present process.

Referring again to FIG. 5, after the CC vehicle speed Vcc is calculated as above in the step 8, the process proceeds to a step 9, wherein the control input Uth is calculated with the predetermined control algorithm such that the CC vehicle speed Vcc becomes equal to the target vehicle speed Vr, as described above, followed by terminating the present process. From the above, the degree of opening of the throttle valve 6a is controlled such that the CC vehicle speed Vcc becomes equal to the target vehicle speed Vr.

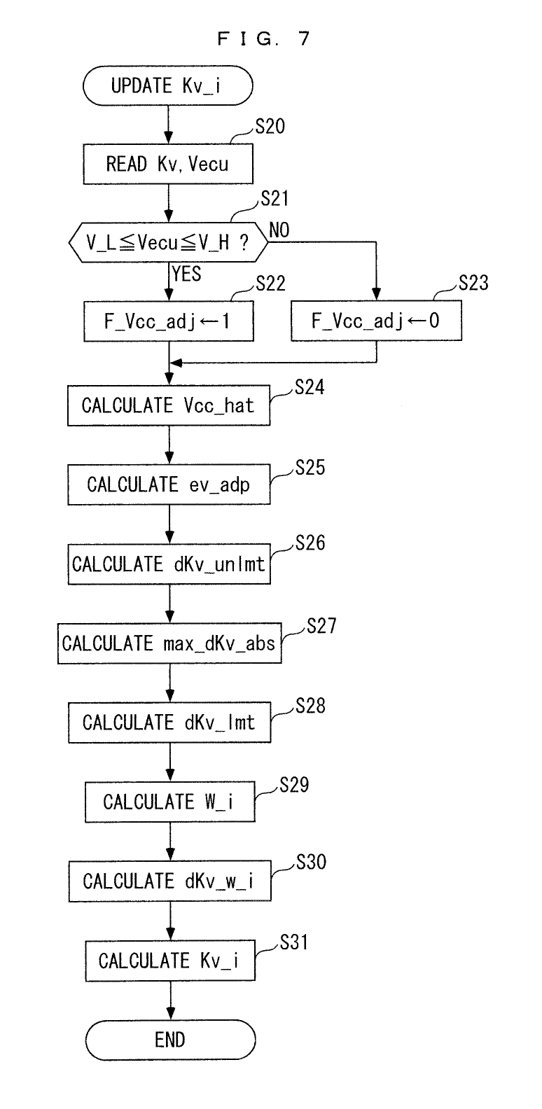

Next, a process for updating the four local correction coefficients Kv_i will be described with reference to FIG. 7. This updating process is performed by the FI ECU 2 at the above-mentioned control period DTn, and at the time of execution of the cruise control process, in synchronism therewith, the updating process is performed in succession with the cruise control process. Note that the values of the local correction coefficients Kv_i updated by this updating process are stored in the RAM of the FI ECU 2 during operation of the engine, and are stored in the E2PROM of the FI ECU 2 when the engine is controlled to stop by turning off the ignition switch by the driver.

As shown in FIG. 7, first, in a step 20, the vehicle speed correction coefficients Kv and the controller vehicle speeds Vecu, stored in the RAM, are read. In this case, the two values Kv and Vecu are calculated at the control period DTk, and hence down-sampled values of the two values Kv and Vecu are read.

Then, the process proceeds to a step 21, wherein it is determined whether or not V_L≦Vecu≦V_H holds. If the answer to this question is affirmative (YES), the process proceeds to a step 22, wherein the above-mentioned update execution flag F_Vcc_adj is set to 1.

On the other hand, if the answer to the question of the step 21 is negative (NO), the process proceeds to a step 23, wherein the update execution flag F_Vcc_adj is set to 0.

In a step 24 following the step 22 or 23, the CC vehicle speed Vcc_hat for update is calculated by the above-mentioned equation (5).

Then, the process proceeds to a step 25, wherein the follow-up error ev_adp is calculated by the above-mentioned equations (6) and (7).

Next, in a step 26, the correction term dKv_unlmt is calculated by the above-mentioned equation (8).

In a step 27 following the step 26, the acceleration limit value max_dKv_abs is calculated by the above-mentioned equation (9).

Then, the process proceeds to a step 28, wherein the limited correction term dKv_lmt is calculated by the above-mentioned equations (10) to (12).

Next, in a step 29, the four weighting function values W_i are calculated by searching the map in FIG. 3B according to the controller vehicle speed Vecu.

In a step 30 following the step 29, the four local correction terms dKv_w_i are calculated by the above-mentioned equation (13).

Then, the process proceeds to a step 31, wherein the four local correction coefficients Kv_i are calculated by the above-mentioned equation (14), followed by terminating the present process.

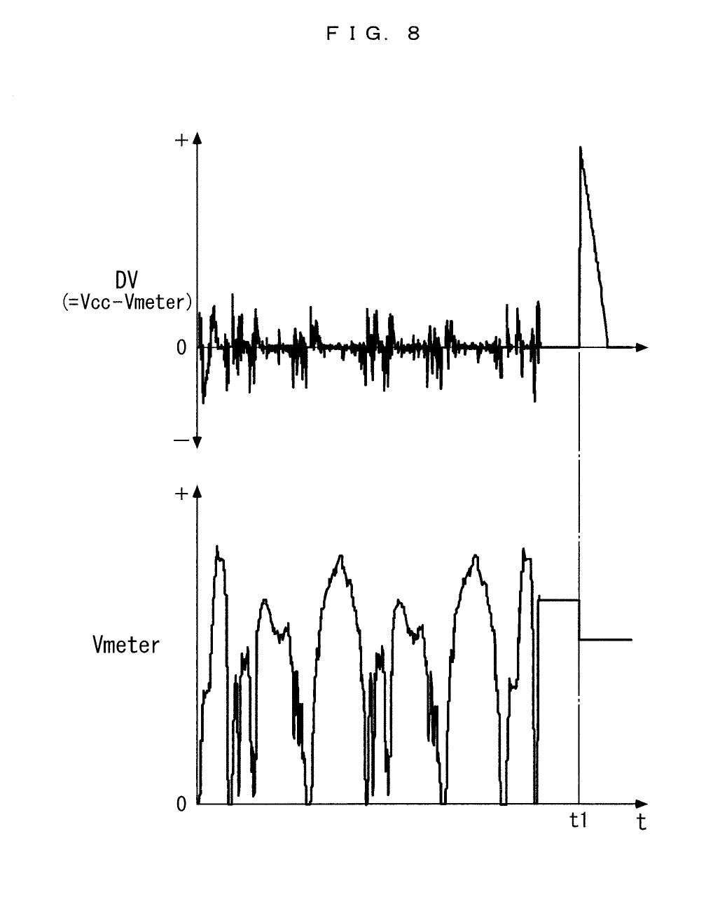

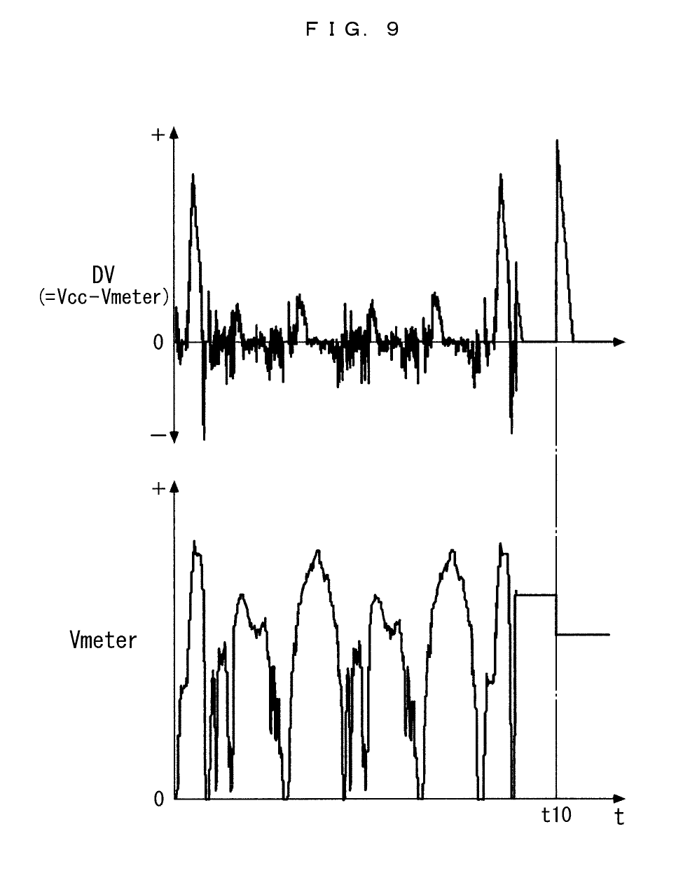

Next, a description will be given of a result of a simulation of the cruise control (hereinafter referred to as the “control result”) performed by the vehicle speed control system 1 according to the present embodiment, configured as above. First, FIG. 8 shows the control result obtained by the present embodiment (hereinafter referred to as the “present control result”). DV in FIG. 8 represents a vehicle speed difference (error) which corresponds to the difference Vcc−Vmeter between the CC vehicle speed Vcc and the display vehicle speed Vmeter. This also applies to FIG. 9.

Further, FIG. 9 shows, for comparison, the control result (hereinafter referred to as the “comparative control result”) obtained in a case where in the equation (1) for calculating the vehicle speed correction coefficient Kv and the equation (13) for calculating the four local correction coefficients Kv_i with the update algorithm, the first weighting function value W_1 is held at a fixed value of 1 and the three weighting function values W_2 to W_4 are held at 0 irrespective of the controller vehicle speed Vecu, and the display vehicle speed Vmeter is changed at the same amplitude and period as those of the present control result.

In the case of the comparative control result, Kv=Kv_1 holds in the above-mentioned equation (1), and only the first local correction coefficient Kv_1 is calculated and updated by the equation (14) for calculating the four local correction coefficients Kv_i.

As is clear from FIGS. 8 and 9, in the case of the comparative control result, as the display vehicle speed Vmeter changes, a relatively large vehicle speed difference DV is generated, but in the case of the present control result, it is known that even when the display vehicle speed Vmeter changes, a degree of generation of the vehicle speed difference DV can be reduced more than in the comparative control result, and the followability of the CC vehicle speed Vcc to the display vehicle speed Vmeter is improved.

Further, in the case of the comparative control result, when the display vehicle speed Vmeter changes in a stepped manner at a time point t10, a convergence time of the vehicle speed difference DV to the value of 0 after t10 is very short, whereas in the case of the present control result, even when the display vehicle speed Vmeter changes in a stepped manner at a time point t1, the convergence time of the vehicle speed difference DV to the value of 0 after t1 is longer than that in the comparative control result. That is, even when the value of the display vehicle speed Vmeter rapidly changes e.g. due to a failure of the meter ECU 11, it is possible to suppress a rapid change in the CC vehicle speed Vcc, whereby it is possible to suppress occurrence of a rapid acceleration state which is not intended by the driver, in the cruise control.

As described above, according to the vehicle speed control system 1 of the present embodiment, the meter controller 40 calculates the display vehicle speed Vmeter based on the vehicle speed detection signal, and transmits the result of calculation to the cruise controller 30 at the predetermined communication period DTn. Further, the cruise controller 30 calculates the controller vehicle speed Vecu based on the vehicle speed detection signal at the predetermined control period DTk, the vehicle speed correction coefficient Kv as the sum of the respective products Kv_i·W_i of the four local correction coefficients Kv_i stored in the E2PROM and the four weighting function values W_i, and the CC vehicle speed Vcc by multiplying the controller vehicle speed Vecu with the vehicle speed correction coefficient Kv. Then, the cruise control is performed such that the CC vehicle speed Vcc becomes equal to the target vehicle speed Vr.

In this case, as described above, since the four local correction coefficients Kv_i are updated with the update algorithm expressed by the equations (3) to (14), and are stored in the E2PROM, the four local correction coefficients Kv_i are stored in the E2PROM in a state provided, in each of the first to fourth regions of the controller vehicle speed Vecu, with the function for causing the correlation between the CC vehicle speed Vcc and the display vehicle speed Vmeter to be reflected thereon, the function for causing the CC vehicle speed Vcc to follow the display vehicle speed Vmeter, and the function for making it possible to avoid occurrence of a rapid acceleration/deceleration state which causes the driver to feel a sense of incompatibility.

Further, the vehicle speed correction coefficient Kv is calculated as the sum of the respective products of the four local correction coefficients Kv_i stored in the E2PROM and the four weighting function values W_i, and the CC vehicle speed Vcc is calculated by multiplying the controller vehicle speed Vecu with the vehicle speed correction coefficient Kv, and hence when the cruise control is performed using the calculated CC vehicle speed Vcc, differently from the vehicle speed control system described in Japanese Laid-Open Patent Publication No. 2007-326494, a steady-state deviation of the CC vehicle speed Vcc from the target vehicle speed Vr is not generated also immediately after the start of the cruise control, and by performing the cruise control from this state, it is possible to quickly cause the display vehicle speed Vmeter to reach the target vehicle speed Vr. Particularly, since the four local correction coefficients Kv_i are stored in the E2PROM, it is possible to calculate the CC vehicle speed Vcc in a state in which a steady-state deviation from the target vehicle speed Vr is not generated, from the start of the engine 3. This makes it possible to improve the controllability of the cruise control and marketability of the system.

Further, since the four local correction coefficients Kv_i have the function which can avoid occurrence of the above-mentioned rapid acceleration/deceleration state, it is possible to avoid occurrence of a rapid acceleration/deceleration state when the cruise control is performed. Particularly, even when the display vehicle speed Vmeter is rapidly reduced e.g. due to a failure of the meter ECU 11, it is possible to avoid occurrence of a rapid acceleration/deceleration state. This makes it possible to improve all of the controllability of the cruise control, and the safety and marketability of the system.

Further, each of the four weighting function values W_i indicates a value of the same sign (positive value) in the corresponding region of the controller vehicle speed Vecu, and each two adjacent weighting function values W_i are set such that they overlap each other with respect to the controller vehicle speed Vecu, and hence even when the correlation between the CC vehicle speed Vcc and the display vehicle speed Vmeter has a characteristic that the correlation rapidly changes with respect to the controller vehicle speed Vecu, it is possible to calculate the vehicle speed correction coefficient Kv and calculate the CC vehicle speed Vcc while avoiding the influence of such rapid change in correlation. This makes it possible to further improve the controllability of the cruise control and the safety and marketability of the system.

Further, since the four local correction coefficients Kv_i are updated and stored in synchronism with the transmission period of the display vehicle speed Vmeter, differently from the vehicle speed control system described in Japanese Laid-Open Patent Publication No. 2007-326494, it is possible to prevent the four local correction coefficients Kv_i from being changed in a stepped manner or showing a vibrational behavior due to a difference between the updating period of the four local correction coefficients Kv_i and the transmission period of the display vehicle speed Vmeter.

Further, when the ACC control mode is selected in the cruise control, the ACC target vehicle speed Vr_a is selected as the target vehicle speed Vr, and hence the target vehicle speed Vr is changed according to the above-mentioned preceding vehicle data. Even when the target vehicle speed Vr is changed as above, the CC vehicle speed Vcc is calculated such that the CC vehicle speed VCC follows the display vehicle speed Vmeter as described above, whereby it is possible to cause the display vehicle speed Vmeter to follow the target vehicle speed Vr with high accuracy, and thereby perform the cruise control with high accuracy.

Although in the above-described embodiment, the vehicle speed control system according to the present invention is applied to the four-wheel type vehicle, byway of example, this is not limitative, but the vehicle speed control system according to the present invention can be applied to one-wheeled to three-wheeled vehicles, or a vehicle having six or more wheels.

Further, although in the above-described embodiment, the controller vehicle speed Vecu is used as the vehicle speed parameter, by way of example, the vehicle speed parameter of the present invention is not limited to this, but may be any suitable parameter insofar as it represents a vehicle speed. For example, as the vehicle speed parameter, the display vehicle speed Vmeter may be used, or a value calculated from the vehicle speed detection signal may be used.

Further, although in the above-described embodiment, as the error between the corrected vehicle speed and the display vehicle speed, the difference Vcc−Vmeter is used, by way of example, the error used in the present invention is not limited to this, but may be any other error insofar as it represents an error between the corrected vehicle speed and the display vehicle speed. For example, a difference Vmeter−Vcc, or an absolute value |Vmeter−Vcc| of the difference may be used as an error, and further, a ratio (Vcc/Vmeter) between the corrected vehicle speed and the display vehicle speed, or the reciprocal (Vmeter/Vcc) thereof may be used. In a case where the ratio between the corrected vehicle speed and the display vehicle speed or the reciprocal thereof is used as an error, a phrase “reducing an error” corresponds to a phrase “converging the ratio between the corrected vehicle speed and the display vehicle speed or the reciprocal thereof to 1”.

On the other hand, although in the above-described embodiment, the gasoline engine 3 is used as the motive power source of the vehicle, by way of example, the motive power source of the present invention is not limited to this, but any suitable motive power source may be used insofar as it generates motive power. For example, an internal combustion engine using gas oil, LPG, or mixed fuel as the fuel, an electric motor, or a combination of an electric motor and an internal combustion engine may be used as the motive power source.

Further, although in the above-described embodiment, as the cruise control method, the method of controlling the degree of opening of the throttle valve 6a, i.e. an intake air amount is used, by way of example, the cruise control method of the present invention is not limited to this, but any suitable method can be used insofar as it is a method of controlling the motive power source such that the corrected vehicle speed becomes equal to the target vehicle speed. For example, torque generated by the motive power source may be controlled such that the corrected vehicle speed becomes equal to the target vehicle speed, or in a case where the motive power source is an internal combustion engine, the amount of fuel supplied to the internal combustion engine may be controlled.

Further, although in the above-described embodiment, the speedometer 12 is used as the vehicle speed-displaying section, by way of example, the vehicle speed-displaying section of the present invention is not limited to this, but any suitable vehicle speed-displaying section may be used insofar as it displays a vehicle speed. For example, as the vehicle speed-displaying section, a digital display type vehicle speed-displaying section (i.e. an LED or LCD type) may be used.

On the other hand, although in the above-described embodiment, the FI ECU 2 as the controller vehicle speed-calculating means and the meter ECU 11 as the display vehicle speed-calculating means are separately provided, by way of example, in the vehicle speed control system according to the present invention, the controller vehicle speed-calculating means and the display vehicle speed-calculating means may be integrally provided. In this case, as the controller vehicle speed-calculating means, a means for calculating the controller vehicle speed, which is distinct from the display vehicle speed, may be used.

It is further understood by those skilled in the art that the foregoing are preferred embodiments of the invention, and that various changes and modifications may be made without departing from the spirit and scope thereof.

What is claimed is:

1. A vehicle speed control system comprising:
vehicle speed-detecting means for outputting a vehicle speed detection signal indicative of a vehicle speed which is a speed of a vehicle;
display vehicle speed-calculating means for calculating a display vehicle speed for display on a vehicle speed-displaying section of the vehicle, based on the vehicle speed detection signal;
controller vehicle speed-calculating means for calculating a controller vehicle speed which is distinct from the display vehicle speed, based on the vehicle speed detection signal;
corrected vehicle speed-calculating means for calculating a corrected vehicle speed by correcting the controller vehicle speed with a correction value;
correction component-updating and storing means for updating and storing a correction component with a predetermined control algorithm while causing a correlation between the corrected vehicle speed and the display vehicle speed to be reflected thereon in association with a vehicle speed parameter indicative of the vehicle speed, such that an error between the corrected vehicle speed and the display vehicle speed is reduced, and storing the updated correction component;
correction value-calculating means for calculating the correction value using the stored correction component;
target vehicle speed-determining means for determining a target vehicle speed which is a target of the corrected vehicle speed; and
cruise control means for performing cruise control for controlling a motive power source of the vehicle, such that the corrected vehicle speed becomes equal to the target vehicle speed.

2. The vehicle speed control system according to claim 1, wherein said correction component-updating and storing means updates the correction component while causing the correlation to be reflected thereon, such that the error is reduced, and at the same time such that an absolute value of acceleration estimated to be generated in the vehicle when the cruise control is performed using the corrected vehicle speed becomes smaller than a predetermined maximum value.

3. The vehicle speed control system according to claim 1, wherein the correction component is formed by a plurality of correction components associated with a plurality of regions of the vehicle speed parameter, respectively,
wherein said correction value-calculating means calculates the correction value as the sum of respective products of the plurality of correction components, and a plurality of function values set in a manner associated with the plurality of regions, respectively, and
wherein the plurality of function values are set such that each function value indicates a value of the same sign in an associated one of the regions, and each two adjacent function values overlap each other with respect to the vehicle speed parameter.

4. The vehicle speed control system according to claim 2, wherein the correction component is formed by a plurality of correction components associated with a plurality of regions of the vehicle speed parameter, respectively,
wherein said correction value-calculating means calculates the correction value as the sum of respective products of the plurality of correction components, and a plurality of function values set in a manner associated with the plurality of regions, respectively, and
wherein the plurality of function values are set such that each function value indicates a value of the same sign in an associated one of the regions, and each two adjacent function values overlap each other with respect to the vehicle speed parameter.

5. The vehicle speed control system according to claim 1, wherein said display vehicle speed-calculating means is provided separately from said correction component-updating and storing means,
the vehicle speed control system further comprising transmission means for transmitting the display vehicle speed calculated by said display vehicle speed-calculating means to said correction component-updating and storing means at a predetermined transmission period,
wherein said correction component-updating and storing means is configured to update and store the correction component in synchronism with the predetermined transmission period, and
wherein said correction value-calculating means calculates the correction value at a predetermined control period which is shorter than the predetermined transmission period.

6. The vehicle speed control system according to claim 2, wherein said display vehicle speed-calculating means is provided separately from said correction component-updating and storing means,
the vehicle speed control system further comprising transmission means for transmitting the display vehicle speed calculated by said display vehicle speed-calculating means to said correction component-updating and storing means at a predetermined transmission period,
wherein said correction component-updating and storing means is configured to update and store the correction component in synchronism with the predetermined transmission period, and
wherein said correction value-calculating means calculates the correction value at a predetermined control period which is shorter than the predetermined transmission period.

7. The vehicle speed control system according to claim 3, wherein said display vehicle speed-calculating means is provided separately from said correction component-updating and storing means,
the vehicle speed control system further comprising transmission means for transmitting the display vehicle speed calculated by said display vehicle speed-calculating means to said correction component-updating and storing means at a predetermined transmission period,
wherein said correction component-updating and storing means is configured to update and store the correction component in synchronism with the predetermined transmission period, and
wherein said correction value-calculating means calculates the correction value at a predetermined control period which is shorter than the predetermined transmission period.

8. The vehicle speed control system according to claim 4, wherein said display vehicle speed-calculating means is provided separately from said correction component-updating and storing means,
the vehicle speed control system further comprising transmission means for transmitting the display vehicle speed calculated by said display vehicle speed-calculating means to said correction component-updating and storing means at a predetermined transmission period,
wherein said correction component-updating and storing means is configured to update and store the correction component in synchronism with the predetermined transmission period, and
wherein said correction value-calculating means calculates the correction value at a predetermined control period which is shorter than the predetermined transmission period.

9. The vehicle speed control system according to claim 1, further comprising:
first target speed-setting means for setting a first target speed according to an operation of a driver of the vehicle; and
second target speed-setting means for setting a second target speed according to the vehicle speed and a positional relationship between the vehicle and a preceding vehicle located ahead of the vehicle, and
wherein said target vehicle speed-determining means selects one of the first target speed and the second target speed as a target speed.

10. The vehicle speed control system according to claim 2, further comprising:
first target speed-setting means for setting a first target speed according to an operation of a driver of the vehicle; and
second target speed-setting means for setting a second target speed according to the vehicle speed and a positional relationship between the vehicle and a preceding vehicle located ahead of the vehicle, and
wherein said target vehicle speed-determining means selects one of the first target speed and the second target speed as a target speed.

11. The vehicle speed control system according to claim 3, further comprising:
first target speed-setting means for setting a first target speed according to an operation of a driver of the vehicle; and
second target speed-setting means for setting a second target speed according to the vehicle speed and a positional relationship between the vehicle and a preceding vehicle located ahead of the vehicle, and
wherein said target vehicle speed-determining means selects one of the first target speed and the second target speed as a target speed.

12. The vehicle speed control system according to claim 4, further comprising:
first target speed-setting means for setting a first target speed according to an operation of a driver of the vehicle; and
second target speed-setting means for setting a second target speed according to the vehicle speed and a positional relationship between the vehicle and a preceding vehicle located ahead of the vehicle, and
wherein said target vehicle speed-determining means selects one of the first target speed and the second target speed as a target speed.

13. The vehicle speed control system according to claim 5, further comprising:
first target speed-setting means for setting a first target speed according to an operation of a driver of the vehicle; and
second target speed-setting means for setting a second target speed according to the vehicle speed and a positional relationship between the vehicle and a preceding vehicle located ahead of the vehicle, and
wherein said target vehicle speed-determining means selects one of the first target speed and the second target speed as a target speed.

14. The vehicle speed control system according to claim 6, further comprising:
first target speed-setting means for setting a first target speed according to an operation of a driver of the vehicle; and
second target speed-setting means for setting a second target speed according to the vehicle speed and a positional relationship between the vehicle and a preceding vehicle located ahead of the vehicle, and
wherein said target vehicle speed-determining means selects one of the first target speed and the second target speed as a target speed.

15. The vehicle speed control system according to claim 7, further comprising:
first target speed-setting means for setting a first target speed according to an operation of a driver of the vehicle; and
second target speed-setting means for setting a second target speed according to the vehicle speed and a positional relationship between the vehicle and a preceding vehicle located ahead of the vehicle, and
wherein said target vehicle speed-determining means selects one of the first target speed and the second target speed as a target speed.

16. The vehicle speed control system according to claim 8, further comprising:
first target speed-setting means for setting a first target speed according to an operation of a driver of the vehicle; and
second target speed-setting means for setting a second target speed according to the vehicle speed and a positional relationship between the vehicle and a preceding vehicle located ahead of the vehicle, and
wherein said target vehicle speed-determining means selects one of the first target speed and the second target speed as a target speed.
